(19) United States
(12) Patent Application Publication
(10) Pub. No.: US 2016/0314802 A1
(43) Pub. Date: Oct. 27, 2016

(54) VOLUME CONTROLLING METHOD AND DEVICE

(71) Applicant: LE SHI ZHI XIN ELECTRONIC TECHNOLOGY (TIANJIN) LIMITED, Beijing (CN)

(72) Inventor: Yujun WANG, Beijing (CN)

(73) Assignee: LE SHI ZHI XIN ELECTRONIC TECHNOLOGY (TIANJIN) LIMITED, Beijing (CN)

(21) Appl. No.: 15/139,083

(22) Filed: Apr. 26, 2016

(30) Foreign Application Priority Data
Apr. 27, 2015 (CN) 201510206110.8

(51) Int. Cl. G10L 21/034; G10L 21/02; G10L 25/06

(52) U.S. Cl. CPC G10L 21/034; G10L 25/06; G10L 21/0205

(57) ABSTRACT

A volume controlling method and a volume controlling device reduce volume adjustment delay. The method includes acquiring a smooth volume and smooth envelope of a signal sampling point at the current moment. An autocorrelation value of the smooth envelope is determined within a first time period and the smooth envelope within each second time period according to the smooth envelope at the current moment and multiple pre-stored smooth envelopes at historical moments. The autocorrelation value having the maximal numerical value is determined from the determined respective autocorrelation values as the maximal autocorrelation value. A combined smooth volume at the current moment is determined according to the smooth volume at the current moment and the maximal autocorrelation value. A volume gain is determined according to the combined smooth volume and a predetermined reference volume. The volume of a voice signal is controlled according to the volume gain at the current moment.

### TECHNICAL FIELD

The present disclosure relates to the field of electronic information technologies, and more particularly, to a volume controlling method and a volume controlling device.

### BACKGROUND

In the field of electronic information technology, voice interaction has become a necessary means for human-machine interaction, or machine-machine interaction. During the course of the voice interaction, auditory experience (i.e., auditory feeing) of a volume for a user is an index for measuring voice interaction quality.

In actual application scenarios, the voice signal volume of a signal source may exist in a situation of little high and little low, which refers to volume jumping. When adjusting a jumping volume, a volume adjustment delay exceeds a certain time scope (such as 100 ms), the user also hears the volume little high or little low. In this way, the user's auditory feeling is worse.

Under normal conditions, after the voice signal is collected at current moment, the voice signal output at the current moment is controlled by the volume gain at the prior moment. Then, the volume gain at the current moment is determined according to the voice signal at the current moment. To be specific, if the volume at the current moment is not changed suddenly, the volume gain at the prior moment is taken as the volume gain at the current moment (i.e., the volume at the prior moment does not need to be adjusted). If the volume at the current moment is changed suddenly (i.e., having volume jumping), the volume gain at the current moment needs to be determined once again (i.e., needing to adjust the volume gain at the prior moment), to control the volume output at the next moment.

The above-mentioned volume adjustment includes the volume gain adjustment, and the volume adjustment delay is in direct proportion to the volume gain adjustment delay. If the volume gain adjustment delay at the prior moment is greater, the volume adjustment delay is also greater. In this way, the output of the volume suddenly changed at the next moment may not be controlled in time, so as to result in that the user also hear the volume fluctuated.

However, in the prior art, the volume gain is mainly determined by a smooth volume of a voice signal sampling point collected at the current moment (for instance, moment t) and a predetermined reference volume by the user, and the volume output is controlled by the volume gain. However, as the smooth volume fails to reflect the situation of the sudden change in the volumes at two adjacent moments, the volumes at two adjacent moments are also unable to be adjusted (such as compensated) in time, which results in greater volume gain adjustment delay, about more than 100 ms. Human ears may clearly distinguish the volume jump, and accordingly, the user's auditory feeling is relatively poor.

### SUMMARY

Embodiments of the present disclosure provide a volume controlling method and a volume controlling device, for reducing a volume adjustment delay and solving a problem of volume jump, so as to further improve auditory feeling of users.

The embodiments of the present disclosure provide a volume controlling method, including:

acquiring a smooth volume and a smooth envelope of a voice signal at the current moment;

determining an autocorrelation value of the smooth envelope within a first time period and the smooth envelope within each second time period according to the smooth envelope at the current moment and multiple pre-stored smooth envelopes at historical moments; wherein, the first time period is a time period including the current moment and the latest historical moment, and the second time periods are multiple time periods including the historical moments;

determining the autocorrelation value having the maximal numerical value from the determined respective autocorrelation values as the maximal autocorrelation value;

determining a combined smooth volume at the current moment according to the smooth volume at the current moment and the maximal autocorrelation value;

determining a volume gain at the current moment according to the combined smooth volume and a predetermined reference volume; and

controlling the volume of a voice signal at next moment according to the volume gain at the current moment.

The embodiments of the present disclosure provide a volume controlling device, including:

an acquisition module configured to acquire a smooth volume and a smooth envelope of a voice signal at the current moment;

a first determination module configured to determine an autocorrelation value of the smooth envelope within a first time period and the smooth envelope within each second time period according to the smooth envelope at the current moment and multiple pre-stored smooth envelopes at historical moments; wherein, the first time period is a time period including the current moment and the latest historical moment, and the second time periods are multiple time periods including the historical moments;

a second determination module configured to determine the autocorrelation value having the maximal numerical value from the determined respective autocorrelation values as the maximal autocorrelation value;

a third determination module configured to determine a combined smooth volume at the current moment according to the smooth volume at the current moment and the maximal autocorrelation value;

a fourth determination module configured to determine a volume gain at the current moment according to the combined smooth volume and a predetermined reference volume; and

a control module configured to control the volume of a voice signal at next moment according to the volume gain at the current moment.

The embodiments of the present disclosure provide a volume controlling method and a volume controlling device. The method includes determining an autocorrelation value of the smooth envelope within a first time period and the smooth envelope within each second time period according to the smooth envelope at the current moment and multiple pre-stored smooth envelopes at historical moments; wherein, the first time period is a time period including the current moment and the latest historical moment, and the second time periods are multiple time periods including the historical moments; determining the autocorrelation value having the maximal numerical value as the maximal autocorrelation value; determining a combined volume at the current moment according to the smooth volume at the current moment and the maximal autocorrelation value; and determining a volume gain at the current moment according to the combined smooth volume and control the volume at next moment. Through actual measurement, when the method is used for determining the volume gain at the current moment, the volume gain adjustment delay is effectively shortened, so that the volume adjustment delay is also effectively shortened. After controlling the volume output, the rate of feeling the volume jumping by human ears may be effectively reduced, or even the volume jumping may be eliminated.

### BRIEF DESCRIPTION OF THE DRAWINGS

The drawings described herein are used for providing further understanding on the present disclosure, and form a part of the present disclosure. The exemplary embodiments of the present disclosure and the description hereof are used for explaining the present disclosure, but not formed as an inappropriate limitation on the present disclosure. In the drawings:

FIG. 1 is a flow diagram of a volume controlling method provided by embodiments of the present disclosure;

FIG. 2 is a time domain waveform diagram of an original voice signal provided by embodiments of the present disclosure;

FIG. 3 is a diagram of a corresponding relationship between a first time period and a smooth envelope and between each second time period and a smooth envelope provided by embodiments of the present disclosure;

FIG. 4 is a spectrum diagram including a smooth volume, a combined smooth volume, a maximal autocorrelation value, a gain and the like, obtained through actual measurement provided by embodiments of the present disclosure;

FIG. 5 is a time domain waveform diagram of an output voice signal provided by embodiments of the present disclosure;

FIG. 6 is a flow diagram of a volume controlling method provided by embodiments of the present disclosure;

FIG. 7 is a flow diagram of a volume controlling method provided by embodiments of the present disclosure; and

FIG. 8 is a structural diagram of a volume controlling device provided by embodiments of the present disclosure.

### DETAILED DESCRIPTION

In order to make the objectives, technical solutions and advantages of the present disclosure more clearly, the technical solutions in the present disclosure will be described clearly and completely with reference to the embodiments and the corresponding drawings in the present disclosure hereinafter. Apparently, the embodiments described are merely partial embodiments of the present disclosure, rather than all embodiments. Other embodiments figured out by those skilled in the art on the basis of the embodiments of the present disclosure without going through creative efforts shall all within the protection of the present disclosure.

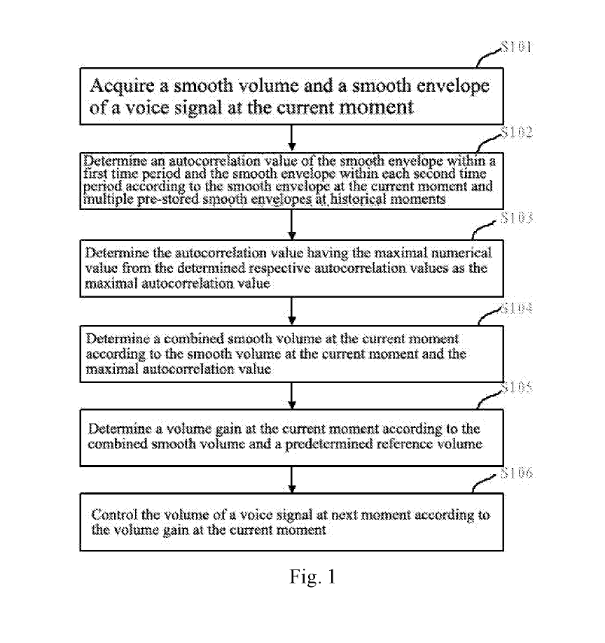

FIG. 1 is a volume controlling method provided by embodiments of the present disclosure, specifically including the following steps:

In step S101, a smooth volume and a smooth envelope of a voice signal at the current moment are acquired.

In the embodiments of the present disclosure, a volume gain determined at prior moment is used for controlling and outputting the volume of a voice signal at the current moment; similarly, a volume gain at the current moment is used for controlling and outputting the volume of a voice signal at next moment.

According to the present disclosure, determining the volume gain at the current moment and controlling the volume at the next moment are taken for example to explain the disclosure.

In the embodiments of the present disclosure, when acquiring a smooth volume and a smooth envelope of a voice signal at the current time (hereinafter referred to as moment t), the volume and the envelope of the voice signal at the moment t need to be acquired firstly, then the volume and the envelope are smoothed to obtain the smooth volume and the smooth envelope.

Acquiring the volume and the envelope of the voice signal at the moment t includes: it is assumed that there is an original voice signal with a time duration of T in a voice dialog system, a relational graph of a time (as shown in horizontal axis) and an amplitude (as shown in longitudinal axis) of the original voice signal is as shown in FIG. 2; from the original voice signal as shown in FIG. 2, the amplitudes x₁ to xₘ of in sampling points (in is a positive integer) of a voice signal at the moment t are acquired, a product gₜ₋₁xᵢ of each amplitude xᵢ (i=1, . . . , m) and the volume gain gₜ₋₁ at the prior moment (hereinafter referred to as the moment t−1) is determined, the squared value s² of the average amplitude gain s̅ is taken as the volume at the current moment Vₜ, and the absolute value |s̅| of the average amplitude gain s̅ is taken as the volume envelope Zₜ at the current moment.

After determining the volume Vₜ at the moment t, a smooth volume Vₜ′ at the moment t may be determined through a formula (1-1).

Vₜ′=(1−λ)(λVₜ₋₁′+Vₜ) (1-1)

In the formula (1-1), λ is an attenuation factor of the smooth volume, and Vₜ₋₁′ is a smooth volume at the moment t−1.

In the formula (1-1), the greater the value of λ is, the smoother the change of the smooth volume Vₜ′ relative to the smooth volume Vₜ₋₁′ becomes. Wherein, λ may be within the scope of 0.50 to 0.99, for instance, the value of λ may be 0.75. The value of λ may be determined according to actual requirements in practical application, which does not make specific limitation herein.

After determining the envelope Zₜ at the moment t, a smooth envelope Zₜ′ at the moment t may be determined through a formula (1-2).

Zₜ′=(1−ω)(ωZₜ₋₁′+Zₜ) (1-2)

In the formula (1-2), ω is an attenuation factor of the smooth envelope, and Zₜ₋₁′ is a smooth envelope at the moment t−1. The greater the value of ω is, the easier the smooth envelope Zₜ′ is smoothed by the smooth envelope Zₜ₋₁′. Wherein, the value of ω may be close to 0, for instance, it may be 0.25 within the scope of 0.00 to 0.50, which may be determined according to the actual requirements in the practical application, and does not make specific limitation herein.

In step S102, an autocorrelation value of the smooth envelope within a first time period and the smooth envelope within each second time period is determined according to the smooth envelope at the current moment and multiple pre-stored smooth envelopes at historical moments.

In the embodiment, the first time period is a time period including the current moment and the latest historical moment, and the second time periods are multiple time periods including the historical moments. The moments of two adjacent time periods may be partially overlapped.

The multiple historical moments may be the historical moments within the set time period b before the current moment, for instance, the multiple historical moments may be any one historical moment between the time period t−5 to the time period t−1 (time period b). The first time period may be one or more historical moments including the current moment t and distancing latest to the moment t, for instance, the first time period may be t−2 to t, the second time period may be the multiple time periods merely including the historical moments, for instance, the second time period may be t−3 to t−1, t−4 to t−2, t−5 to t−3 and t−6 to t−4.

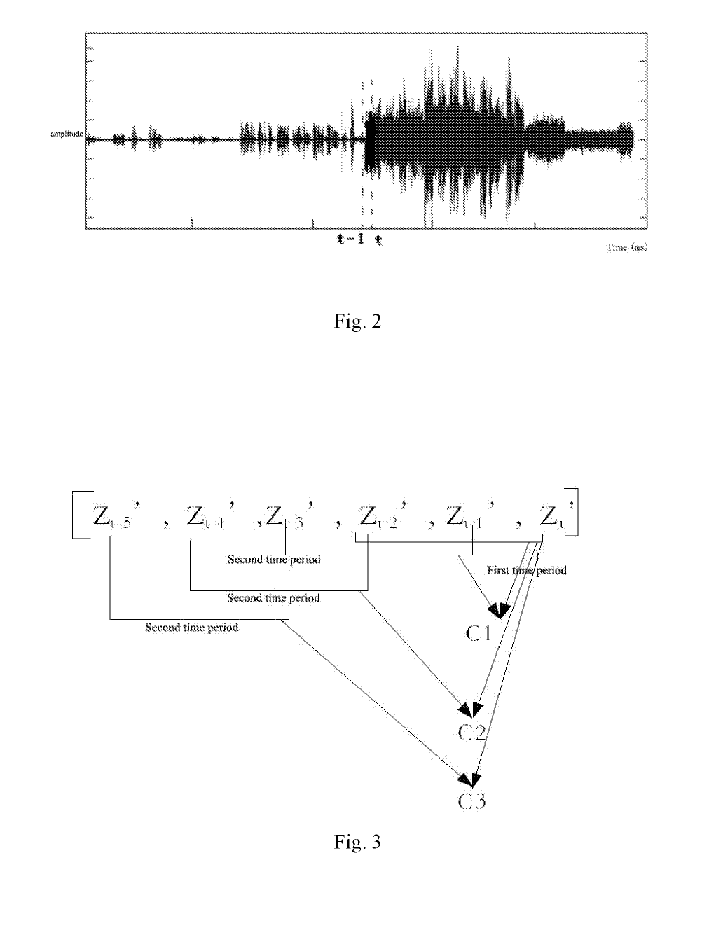

In the actual application scenario, after determining the smooth envelope at the moment t every time, various smooth envelopes within the set time period b may be stored, and various smooth envelopes within the time periods t−5 to 5 may be stored in the above example. The corresponding relation of various stored smooth envelopes Zₜ₋₅′ to Zₜ′ and various time periods are as shown in FIG. 3.

In the actual application scenario, determining the volume gain at the moment t refers to determining the volume gain of a voice signal in a voiced segment (that is s signal in a pitch period), rather than determining a volume gain of a voice signal in a light voice segment that has no the pitch period and is similar to a random noise. This needs to detect whether the voice signal at the moment t is a signal in a pitch period according to an autocorrelation function.

When the autocorrelation function of the multiple smooth envelopes within the first time period and the multiple smooth envelopes within the second time period has a maximal value, the voice signal corresponding to the first time period may be determined as the signal in the pitch period.

It should be noted that, a moment generates an envelope value. As the first time period includes the current moment and at least one historical moment, the first time period includes multiple smooth envelopes corresponding to multiple moments (for instance, at least including two smooth envelopes).

Therefore, in the embodiments of the present disclosure, the maximal value may be determined from the multiple correlation values by determining the autocorrelation value of the multiple smooth envelopes within the first time period and various smooth envelopes within each second time period, so that the voice signal having a signal in a pitch period may be determined according to the maximal value. The autocorrelation function described in the present disclosure is a short time autocorrelation function (which is also referred as a real time autocorrelation function).

In the embodiments of the present disclosure, when determining the autocorrelation value of the multiple smooth envelopes within the first time period and various smooth envelopes within each second time period, the autocorrelation value of the smooth envelope within two time periods is specifically calculated by a sliding window.

Following the example above, the window length of the sliding window is assumed to correspond to three envelope values (also corresponding to three moments), and the sliding window is started from the time periods t to t−2 (that is the first time period) to slide toward the direction of the historical moment, one moment is moved toward the direction of the historical moment as long as sliding once. In this way, the sliding window needs to slide for three times with respect to the current moment in allusion to the time length of t−5 to 5, and the time periods corresponding to sliding for three times (that is the second time period) are t−3 to t−1, t−4 to t−2 and t−5 to t−3.

In this way, an autocorrelation value C1 of the first period Zₜ₋₂′ to Zₜ′ and the second period Zₜ₋₃′ to Zₜ₋₁′ may be determined through a formula C1=Σᵢ₌₀ⁱ⁼²Z′ₜ₋ᵢZ′ₜ₋₃₊ᵢ; an autocorrelation value C2 of the first period Zₜ₋₂′ to Zₜ′ and the second period Zₜ₋₄′ to Zₜ₋₂′ may be determined through a formula C2=Σᵢ₌₀ⁱ⁼²Z′ₜ₋ᵢZ′ₜ₋₄₊ᵢ, and a autocorrelation value C3 of the first period Zₜ₋₂′ to Zₜ′ and the second period Zₜ₋₅′ to Zₜ₋₃′ may be determined through a formula C3=Σᵢ₌₀ⁱ⁼²Z′ₜ₋ᵢZ′ₜ₋₅₊ᵢ.

Of course, various autocorrelation values are not limited to be calculated by employing the formulas above. C1, C2 and C3 may be specifically calculated by the following formulas: C1=Σᵢ₌₀ⁱ⁼²Z′ₜ₋ᵢZ′ₜ₋₃₊ᵢ; C2=Σᵢ₌₀ⁱ⁼²Z′ₜ₋ᵢZ′ₜ₋₂₊ᵢ; and C3=Σᵢ₌₀ⁱ⁼²Z′ₜ₋ᵢZ′ₜ₋₃₊ᵢ.

In step S103, the autocorrelation value having the maximal numerical value from the determined respective autocorrelation values is determined as the maximal autocorrelation value Cₘₐₓ.

Following the example above, the autocorrelation value having the maximal numerical value from the determined respective autocorrelation values C1 to C3 is determined as the maximal autocorrelation value. If C1 is assumed as the maximal one, C1 is the maximal autocorrelation value Cₘₐₓ. The maximal autocorrelation value is also the maximal value of the autocorrelation function, and the maximal value explains that the voice signal at the moment t has a signal in a pitch period.

In step S104: a combined smooth volume \hat{V} at the current moment is determined according to the smooth volume at the current moment and the maximal autocorrelation value Cₘₐₓ.

The combined smooth volume \hat{V} at the moment t is determined according to the smooth volume Vₜ′ at the moment t determined in the step S101 and the maximal autocorrelation value Cₘₐₓ determined in step S103.

In the embodiments of the present disclosure, the combined smooth volume is a linear combination between the smooth volume at the moment t and the maximal autocorrelation value.

The combined smooth volume \hat{V} may be determined through a formula (1-3).

\hat{V}=αVₜ′+βCₘₐₓ (1-3)

In the formula (1-3), α is a coefficient of the smooth volume Vₜ′ at the moment t, β is a coefficient of the maximal autocorrelation value Cₘₐₓ, and α and β may be preset according to the actual requirements.

The relationship between α and β may be β=(1−α)/I, wherein, I is the number of the multiple smooth envelopes corresponding to the multiple moments within the first time period respectively.

The transformation of the formula (13) is as shown in a formula (1-4).

\hat{V}=αVₜ′+(1−α)Cₘₐₓ/I (1-4)

That is, the combined smooth volume at the moment t is determined according to the smooth volume at the moment t and the maximal autocorrelation value, to be specific, a ratio Cₘₐₓ/I of the maximal autocorrelation value Cₘₐₓ and the quantity I of the smooth envelopes within the first time period may be determined as an average maximal autocorrelation value; a weighted average value αVₜ′+(1−α)Cₘₐₓ/I of the smooth volume Vₜ′ at the moment t and the average maximal autocorrelation value Cₘₐₓ/I is determined, wherein α and 1−α are weights of the smooth volume Vₜ′ and Cₘₐₓ/I respectively, the sum of α and 1−α is 1, and the weighted average value αVₜ′+(1−α)Cₘₐₓ/I is taken as the combined smooth volume of the sampling point at the moment t.

The weight α may be 0.60 to 0.99. Optionally, the weight α may be 0.80, 0.85 and the like. The ratio of the weight α further needs to be set according to the actual requirements, which is not specifically limited herein.

In step S105: a volume gain at the moment t is determined according to the combined smooth volume and a predetermined reference volume.

The difference gₜ=\hat{V}−Vᵣ between the combined smooth volume \hat{V} and the predetermined reference volume Vᵣ is calculated, and the difference gₜ is the volume gain at the moment t.

In step S106, the volume of a voice signal sampling point at next moment is controlled according to the volume gain at the current moment.

It is assumed that a sampling rate is 16/ms, a volume controlling device collects amplitudes x₁ to x₁₆ of 16 sampling points at the moment t+1, acquires a volume gain gₜ at the moment t, and then calculates the product of xᵢ and gₜ respectively to obtain xᵢ gₜ (i=1, . . . , 16), and 16 xᵢ gₜ (i=1, . . . , 16) are taken as voice signal output values.

In the method as shown in FIG. 1, the autocorrelation value of the multiple smooth envelopes within the first time period and various smooth envelopes within each second time period according to the smooth envelope at the moment t and multiple pre-stored smooth envelopes at the historical moments; the autocorrelation value having the maximal numerical value from the determined respective autocorrelation values is determined as the maximal autocorrelation value; the combined smooth volume at the moment t according to the smooth volume at the moment t and the maximal autocorrelation value; the volume gain of the sampling point at the moment t is determined according to the combined smooth volume and the predetermined reference volume; and the volume of the voice signal sampling point at the next moment is controlled according to the volume gain at the current moment. Through actual measurement, when the method is used for determining the volume gain at the current moment, the volume gain adjustment delay is effectively shortened, so that the volume adjustment delay is also effectively shortened. After controlling the volume output, the rate of feeling the volume jumping by human ears may be effectively reduced, or even the volume jumping may be eliminated.

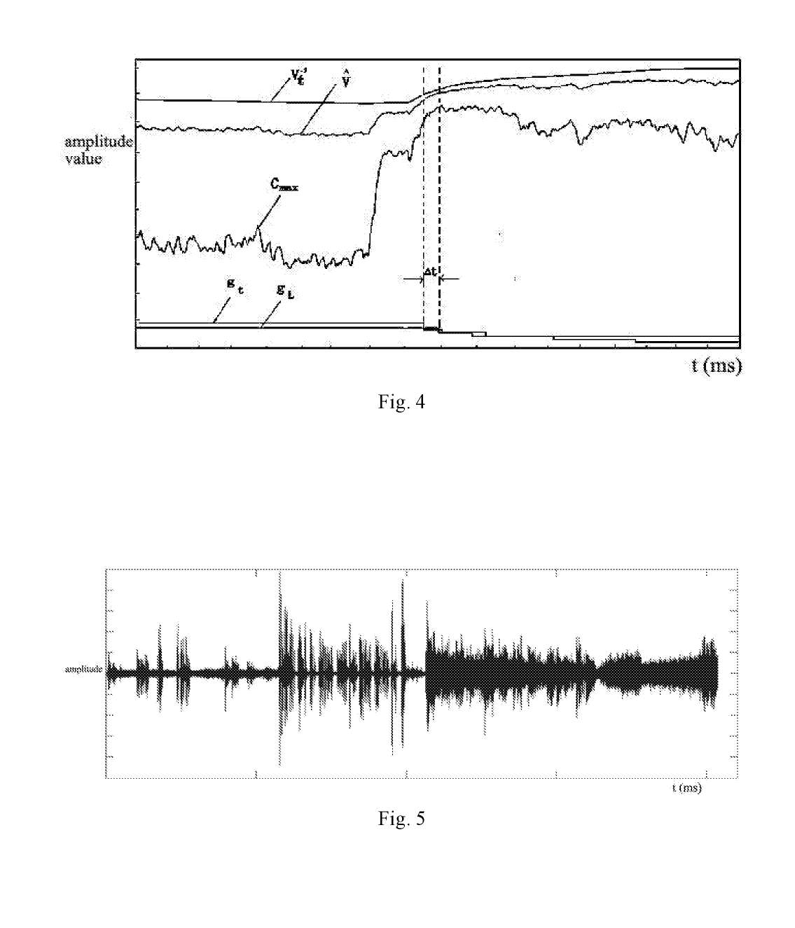

FIG. 4 is a spectrum diagram obtained by actual measurement. In FIG. 4, the horizontal axis represents a period of time of an original voice signal as shown in FIG. 2, the longitudinal axis represents the amplitude value of various curves in the spectrum diagram, and the curves from up to down are as follows respectively:

The first curve represents a variation curve diagram of a time-varying smooth volume Vₜ′ of an original voice signal as shown in FIG. 2; the second curve represents a variation curve diagram of a time-varying combined smooth volume of the original voice signal as shown in FIG. 2; the third curve represents a variation curve diagram of a time-varying maximal autocorrelation value Cₘₐₓ of the original voice signal as shown in FIG. 2; the fourth curve represents a variation curve diagram of a volume gain gₜ determined according to the combined smooth volume \hat{V} and the predetermined reference volume value, that is, the variation curve diagram of the volume gain determined by the method as shown in FIG. 1 of the present disclosure; and the fifth curve represents a variation curve diagram of a volume gain g_{L} determined according to the combined smooth volume Vₜ′ at the moment t and the predetermined reference volume value, that is, the variation curve diagram of the volume gain determined according to the prior art.

It is appreciated according to various inflection points of the fourth curve gₜ and the fifth curve g_{L} and the variation trend of the inflection points, the volume of a voiced voice signal (signal in pitch period) corresponding to the inflection point is increased suddenly, the volume gain in the inflection point is declined compared to the volume gain at the prior moment. Moreover, it can be known according to the first inflection point of the fourth curve gₜ and the fifth curve g_{L}, the time corresponding to each inflection point of the fourth curve gₜ is earlier than the time corresponding to each inflection point of the fifth curve g_{L}; that is to say, the variation curve diagram of the volume gain g_{L} determined according to the smooth volume Vₜ′ at the moment t and the predetermined reference volume falls behind the variation curve diagram of the volume gain gₜ determined according to the combined smooth volume \hat{V} and the predetermined reference volume on the time, and the delay time is about Δt as shown in FIG. 4. Correspondingly, compared with the time point when the volume of the voice signal is changed suddenly, for the volume gain determined according to the method as shown in FIG. 1 of the present disclosure, the volume gain adjustment delay is less than the volume gain adjustment delay according to the smooth volume in the prior art. As the volume gain adjustment delay by the method as shown in FIG. 1 of the present disclosure is less, accordingly, the volume adjustment delay is reduced correspondingly. After controlling the volume output, the rate of feeling the volume jumping by human ears may be effectively reduced, or even the volume jumping may be eliminated.

In addition, it is appreciated by comparing the curve diagrams as shown in FIG. 2 and FIG. 5 (the volume controls the output result), after controlling the volume by the method as shown in FIG. 1 of the present disclosure, the higher volume is inhibited, and the lower volume is increased, so that the rate of change of the volume of the voice signal with a period of time remains within a smaller scope. In this way, the voice signal output quality may be effectively improved, so as to effectively improve the auditory feeling of a user.

It should be noted that the combined smooth volume and the predetermined reference volume may be a combined smooth volume and a predetermined reference volume after normalization respectively.

For instance, after acquiring the smooth volume and the smooth envelope in step S101, the smooth volume may be subjected to the normalization processing, and the smooth envelope may be subjected to the normalization processing. Of course, the volume and the envelope before smoothing may also be subjected to the normalization processing, and after smoothing, the normalization processing is not needed once again. If the smooth volume and the smooth envelope are normalization values, the predetermined reference volume also needs to be adjusted as the normalization value, for example, the predetermined reference volume is set within the scope of 0 to 1. When adjusting the predetermined reference volume, the user may adjust a floating-point number to control the value of the predetermined reference volume, so as to control the size of the output volume.

With a view to the actual application context, compared the volume of the voice signal at the current moment with the volume at the moment t−1, the rate of change of the volume is less (for instance, the volume may not be changed suddenly, but changed slowly). Therefore, after the voice signal sampling point is collected at the moment t, the volume gain at the moment t may not need to be adjusted.

Therefore, in the embodiments of the disclosure, before determining the combined smooth volume at the moment t according to the smooth volume at the moment t and the maximal autocorrelation value, whether the maximal autocorrelation value at the moment t satisfies the setting conditions needs to be determined. The volume gain gₜ₋₁ at the moment t−1 may be adjusted according to the method as shown in FIG. 1 of the present disclosure if the maximal autocorrelation value at the moment t satisfies the setting conditions, and the adjusted gₜ₋₁ (that is the volume gain gₜ at the moment t determined by the method as shown in FIG. 1) is taken as the volume gain gₜ at the moment t. Otherwise, the volume gain gₜ₋₁ at the moment t−1 is taken as the volume gain gₜ at the moment t to adjust the volume gain at the next moment.

In the embodiment, determining whether the maximal autocorrelation value at the moment t satisfies the setting conditions is described as follows.

If the maximal autocorrelation value at the current moment exceeds a predetermined maximal autocorrelation threshold, and each maximal autocorrelation value determined between the current moment t and the historical moment t−j has a local peak value, wherein j is a positive integer greater than 1, the maximal autocorrelation value at the current moment t is determined to satisfy the setting conditions, otherwise, the maximal autocorrelation value at the current moment t is determined not to satisfy the setting conditions.

For instance, it is assumed that the maximal autocorrelation value at the moment t is Cₘₐₓ₁, the predetermined maximal autocorrelation threshold is C_{ys}, the latest historical time period is t−4 to t−1, the maximal autocorrelation value at various historical moments within the historical time period is Cₘₐₓ₅ (corresponding to the moment t−4), Cₘₐₓ₄ (corresponding to the moment t−3), Cₘₐₓ₃ (corresponding to the moment t−2), and Cₘₐₓ₂ (corresponding to the moment t−1); whether Cₘₐₓ₁ is greater than C_{ys} is judged, and whether the intermediate value Cₘₐₓ₃ is a peak value (that is the maximal value) in the maximal autocorrelation values Cₘₐₓ₀ to Cₘₐₓ₅ among the moments t−4 to t is judged; if Cₘₐₓ₁ is greater than C_{ys} and Cₘₐₓ₃ is the peak value, the maximal autocorrelation value at the moment t is determined to satisfy the setting conditions; if Cₘₐₓ₁ is not greater than C_{ys} and Cₘₐₓ₃ is not the peak value, the maximal autocorrelation value at the moment t is determined not to satisfy the setting conditions.

With a view to the actual application context, after determining the volume gain gₜ at the moment t, the volume gain gₜ may be likely to change suddenly compared to the volume gain gₜ₋₁ at the moment t−1. Therefore, in the embodiment of the disclosure, after determining the volume gain gₜ at the moment t, and before controlling the volume at the next moment according to the volume gain, the method further includes: smoothing the volume gain.

The smooth volume gain gₜ′ may be determined by a formula (1-5).

gₜ′=(1−θ)(θgₜ₋₁′+g) (1-5)

In the formula (1-5), θ is an attenuation factor of the smooth volume gain, gₜ₋₁′ is a smooth volume gain at the moment t−1, gₜ is a volume gain at the moment t (that is, the volume gain without smoothing), and the attenuation factor θ can be set according to the actual requirements.

Further, with a view to the actual application context, as the volume gain determined has a delay effect, this may result in that the volume output exceeds the user's predetermined reference volume when controlling the volume at the subsequent moment according to the smooth volume gain gₜ′.

Therefore, before controlling the volume at the next moment according to the volume gain (that is, the smooth volume gain) after smoothing, the method further includes the following steps.

The gain limit is performed on the volume gain smoothed, for instance, a gain threshold may be pre-determined. When the volume gain smooth exceeds the gain threshold, the volume gain smoothed is reduced to the gain threshold or within the scope of the gain threshold. Of course, the gain limit performed on the volume gain smooth in the embodiment of the present disclosure may be processed by means of the existing conventional means, which will not be elaborated herein.

With a view to the actual application context, an extra channel noise may be generated by frequently adjusting the volume gain, the extra channel signal may increase the rate of change of the volume gain, which results in a problem of inaccurate volume gain.

Therefore, in order to avoid the above-mentioned problem, before controlling the volume at the next moment according to the volume gain, the method further includes the following steps.

Gain difference limit is performed on the volume gain after the gain limit, and the volume at the next moment is controlled according to the volume obtained after the gain difference limit. For the gain difference limit, that is to say, the variance of the volume gain after the gain limit at the moment t is limited, specifically, if the variance is greater than the preset variance, the volume gain after the gain limit needs to be adjusted, so that the variance of the volume gain adjusted is within the preset scope of the variance.

In order to explain the whole technical solution in the present disclosure more clearly, the flow of the voice control in the present disclosure will be simply described with reference to the drawings hereinafter.

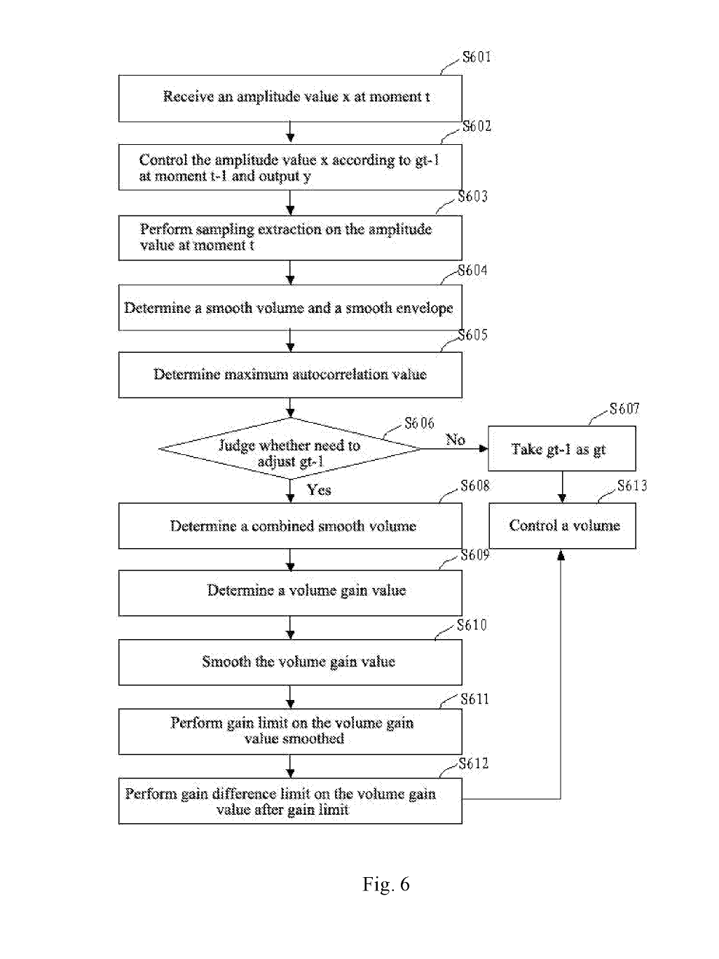

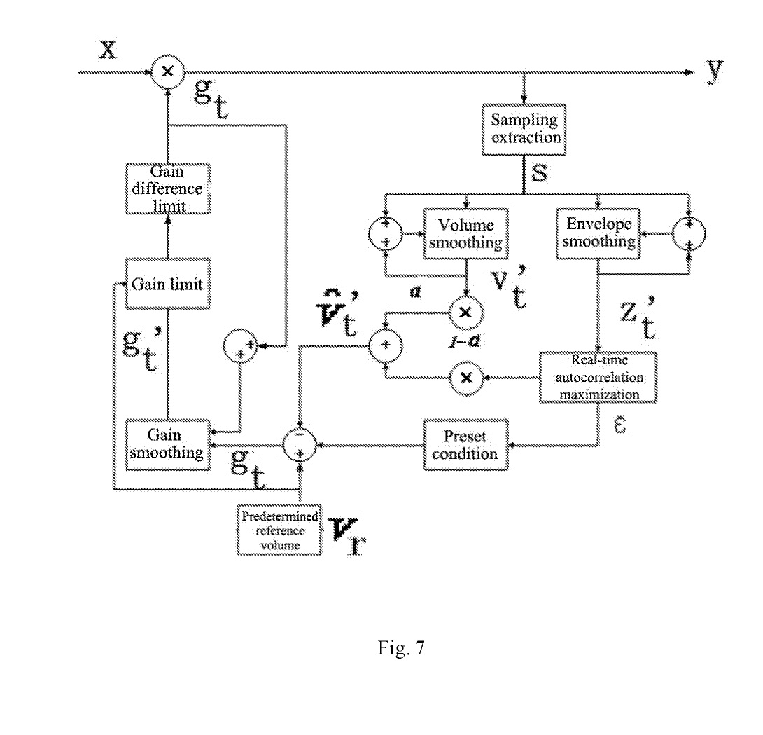

Referring to FIG. 6 and FIG. 7, the volume controlling method provided by the embodiments of the present disclosure mainly includes the following steps.

In step S601: the amplitudes of various sampling points at the moment t are received, for instance x1 to x16, x (x may be any one value of x1 to x16) as shown in FIG. 7 is the amplitude of each sampling point.

In step S602: the amplitude x of each sampling point is controlled and output according to the volume gain at the moment t−1, for instance, the value y in FIG. 7 is an output value.

In step S603: the amplitude of each sampling point at the moment t is performed the sampling extraction, the sampling extraction may also to be determined the average gain amplitude s at the moment t.

In step S604: the volume and the envelope are determined according to the average gain amplitude s̅, then the volume is smoothed, and the envelope is smoothed.

In step S605: the maximal autocorrelation value at the moment t is determined according to the envelope smoothed.

In step S606: whether needing to adjust the volume gain gₜ₋₁ at the moment t−1 is judged according to the preset condition, step S608 is performed if need to adjust the volume gain gₜ₋₁ at the moment t−1, and step S607 is performed if not need to adjust the volume gain gₜ₋₁ at the moment t−1.

In step S607: the volume gain gₜ₋₁ at the moment t−1 is taken as the volume gain gₜ at the moment t, that is gₜ is equal to gₘ, then step S613 is performed.

In step S608: the combined smooth volume is determined according to the smooth volume and the maximal autocorrelation value.

In step S609: the volume gain at the moment t is determined according to the combined smooth volume and the predetermined reference volume.

In step S610: the volume gain is smoothed.

In step S611: the gain limit is performed on the volume gain smoothed.

In step S612: the gain difference limit is performed on the volume gain after the gain limit, and the volume gain after the gain difference limit is taken as the volume gain gₜ at the moment t.

In step S613: the volume of the voice signal at the next moment or the subsequent moment is controlled according to the volume gain gₜ determined at the moment t.

It should be noted that, determining whether need to adjust the volume gain gₜ₋₁ at the moment t−1 according to the preset condition refers to: judging whether the maximal autocorrelation value determined in step S606 satisfies the setting conditions: if the maximal autocorrelation value at the current moment exceeds the predetermined maximal autocorrelation threshold, and each maximal autocorrelation value determined between the current moment t and the historical moment t−j has a local peak value, determining that the maximal autocorrelation value at the current moment satisfies the setting conditions, wherein j is a positive integer greater than 1, if the maximal autocorrelation value at the current moment does not exceed the predetermined maximal autocorrelation threshold, or each maximal autocorrelation value determined between the current moment t and the historical moment t−j does not have a local peak value, determining that the maximal autocorrelation value at the current moment does not satisfy the setting conditions.

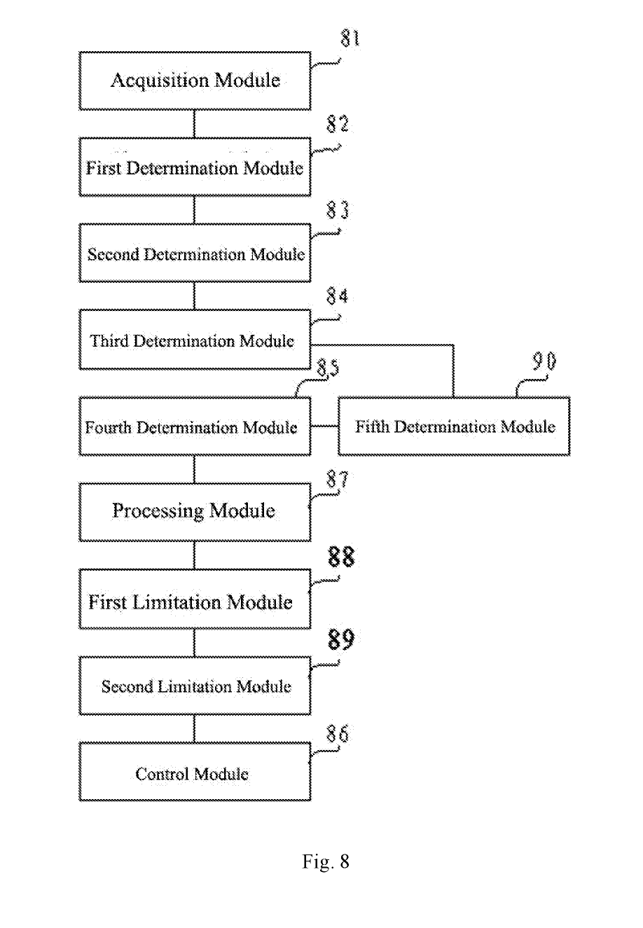

The above is the volume controlling method provided in the embodiments of the present disclosure. The embodiments of the present disclosure further provide a volume controlling device based on the same thought, as shown in FIG. 8.

FIG. 8 is a volume controlling device provided by the embodiments of the present disclosure, which includes an acquisition module 81, a first determination module 82, a second determination module 83, a third determination module 84, a fourth determination module 85, and a control module 86.

The acquisition module 81 is configured to acquire a smooth volume and a smooth envelope of a voice signal at the current moment.

The first determination module 82 is configured to determine an autocorrelation value of the smooth envelope within a first time period and the smooth envelope within each second time period according to the smooth envelope at the current moment and multiple pre-stored smooth envelopes at historical moments; wherein, the first time period is a time period including the current moment and the latest historical moment, and the second time periods are multiple time periods including the historical moments.

The second determination module 83 is configured to determine the autocorrelation value having the maximal numerical value from the determined respective autocorrelation values as the maximal autocorrelation value.

The third determination module 84 is configured to determine a combined smooth volume at the current moment according to the smooth volume at the current moment and the maximal autocorrelation value.

The fourth determination module 85 is configured to determine a volume gain at the current moment according to the combined smooth volume and a predetermined reference volume.

The control module 86 is configured to control the volume of a voice signal at next moment according to the volume gain at the current moment.

Optionally, the third determination module 84 is configured to: determine a ratio of the maximal autocorrelation value to the quantity of the smooth envelope within the first time period as the average maximal autocorrelation value, wherein, the smooth envelope within the first time period is the smooth envelope at each time within the first time period, determine a weighted average value of the smooth volume at the current moment and the maximal average autocorrelation value, and take the weighted average value as the combined smooth volume at the current moment.

Optionally, the acquisition module 81 is configured to: acquire an amplitude of multiple sampling points of the voice signal at the current moment, calculate the product of the amplitude of each sampling point and the volume gain at the previous moment as a gain amplitude, determine the average value of the gain amplitudes of the multiple sampling points as an average amplitude, and determine the smooth volume and the smooth envelope according to the average amplitude.

Optionally, the device further includes a processing module 87, a first limitation module 88, and a second limitation module 89.

The processing module 87 is configured to smooth the volume gain.

The first limitation module 88 is configured to perform gain limit on the volume gain smoothed.

The second limitation module 89 is configured to perform gain difference limit on the volume gain after the gain limit, and take the volume gain after the gain difference limit as the volume gain at the current moment. Optionally, the device further includes a fifth determination module 90.

The fifth determination module 90 is configured to determine the maximal autocorrelation value as a maximal autocorrelation value satisfying setting conditions before determining the combined smooth volume at the current moment according to the smooth volume at the current moment and the maximal autocorrelation value.

In the embodiment, if the maximal autocorrelation value at the current moment exceeds a predetermined maximal autocorrelation threshold, and each maximal autocorrelation value determined between the current moment t and the historical moment t−j has a local peak value, determine that the maximal autocorrelation value at the current moment satisfies the setting conditions, wherein j is a positive integer greater than 1.

In conclusion, a volume controlling method and a volume controlling device are provided in the embodiments of the present disclosure. The method includes the following steps of determining an autocorrelation value of the multiple smooth envelopes within a first time period and various smooth envelopes within each second time period according to the smooth envelope at the current moment and multiple pre-stored smooth envelopes at historical moments within the latest set time period; determining the autocorrelation value having the maximal numerical value as the maximal autocorrelation value; determining a combined volume at the current moment according to the smooth volume at the current moment and the maximal autocorrelation value; and determining a volume gain at the current moment according to the combined smooth volume and control the volume at next moment. Through actual measurement, when the method is used for determining the volume gain at the current moment, the volume gain adjustment delay is effectively shortened, so that the volume adjustment delay is also effectively shortened. After controlling the volume output, the rate of feeling the volume jumping by human ears may be effectively reduced, or even the volume jumping may be eliminated.

A volume controlling apparatus provided by the embodiments of the present disclosure, which comprising:

a processor; and

an memory for storing commands executed by the processor;

wherein the processor is configured to:

acquiring a smooth volume and a smooth envelope of a voice signal at the current moment; determining an autocorrelation value of the smooth envelope within a first time period and the smooth envelope within each second time period according to the smooth envelope at the current moment and multiple pre-stored smooth envelopes at historical moments; wherein, the first time period is a time period comprising the current moment and the latest historical moment, and the second time periods are multiple time periods comprising the historical moments; determining the autocorrelation value having the maximal numerical value from the determined respective autocorrelation values as the maximal autocorrelation value; determining a combined smooth volume at the current moment according to the smooth volume at the current moment and the maximal autocorrelation value; determining a volume gain at the current moment according to the combined smooth volume and a predetermined reference volume; and controlling the volume of a voice signal at next moment according to the volume gain at the current moment.

Optionally, the processor is configured to: determining a ratio of the maximal autocorrelation value to the quantity of the smooth envelope within the first time period as an average maximal autocorrelation value; wherein, the smooth envelope within the first time period is the smooth envelope at each moment within the first time period; determining a weighted average value of the smooth volume at the current moment and the maximal average autocorrelation value; and adopting the weighted average value as the combined smooth volume at the current moment.

Optionally, the processor is configured to: acquiring the amplitude of multiple sampling points of the voice signal at the current moment; calculating the product of the amplitude of each sampling point and the volume gain at the previous moment as a gain amplitude; determining the average value of the gain amplitudes of the multiple sampling points as an average amplitude; and determining the smooth volume and the smooth envelope according to the average amplitude.

Optionally, the processor is further configured to: smoothing the volume gain; performing gain limit on the volume gain smoothed; and performing gain difference limit on the volume gain after the gain limit, and adopting the volume gain after the gain difference limit as the volume gain at the current moment.

Optionally, the processor is further configured to: determining the maximal autocorrelation value as a maximal autocorrelation value satisfying setting conditions; wherein, if the maximal autocorrelation value at the current moment exceeds a predetermined maximal autocorrelation threshold, and each maximal autocorrelation value determined between the current moment t and the historical moment t−j has a local peak value, determining that the maximal autocorrelation value at the current moment satisfies the setting conditions; wherein, j is a positive integer greater than 1.

The present disclosure is described with reference to a flow diagram and/or a block diagram of a method, a device (system), and a computer program product according to the embodiments of the present disclosure. It should be understood each flow and/or block in the flow diagram and/or the block diagram, and the combination of the flow and/or block in the flow diagram and/or the block diagram may be implemented by computer program instructions. These computer program instructions may be provided for a processor of a general purpose computer, a dedicated computer, an embedded processor or other programmable data processing equipment to generate a machine, so that a device for implementing function designated in one flow or multiple flows of the flow diagram and/or one frame or multiple frames of the block diagram is generated by the instruction performed by the processor of the computer or the other programmable data processing equipment.

These computer program instructions may also be stored in the computer readable memory capable of guiding the computer or the other programmable data processing equipment to work in a specific manner, so that the instruction stored in the computer readable memory generates a manufactured material including an instruction device. The function designated in one flow or multiple flows of the flow diagram and/or one block or multiple blocks of the block diagram is implemented by the instruction device.

These computer program instructions may also be loaded in the computer or other programmable data processing equipment, which implement a series of operation steps in the computer or other programmable data processing equipment to generate the process implemented by the computer, so that the instruction implemented on the computer or other programmable data processing equipment provides the step for implementing the function designated in one flow or multiple flows of the flow diagram and/or one block or multiple blocks of the block diagram.

In a typical configuration, the computing device includes one or multiple processor (CPU), an input/output interface, a network interface and an internal memory.

The internal memory may include a volatile memory in a computer readable medium, a random access memory (RAM) and/or a nonvolatile internal memory and other forms, for instance, read-only memory (ROM) or flash RAM (flash RAM). The internal memory is an example of the computer readable medium.

The computer readable medium includes permanent and volatile, and movable and non-movable media capable of implementing information storage by any method or technology. The information may be computer readable instruction, data structure, module of program or other data. The example of the storage medium of the computer includes, but not limited to a phase change memory (PRAM), a static random access memory (SRAM), a dynamic random access memory (DRAM), other types of random access memory (RAM), a read-only memory (ROM), an electric erasable programmable read-only memory (EEPROM), a flash RAM or other internal memory technology, a CD-random access memory (CD-ROM), a digital versatile disc (DVD) or other optical memory, and a cassette magnetic tape, magnetic tape magnetic disk memory or other magnetic memory device or any other non-transmission media, which may be used for storing the information capable of being accessed by the computing device. According to the definition in the context, the computer readable medium does not include a transitory computer readable media (transitory media), for instance, modulated data signal and carrier.

It should be further noted that, the terms “include”, “comprise” or any variation thereof herein refer to “include but not limited to”. Therefore, in the context of a process, method, commodity or device that includes a series of elements, the process, method, commodity or system not only includes such elements, but also includes other elements not specified expressly, or may include inherent elements of the process, method, commodity or device. Unless otherwise specified, in the context of “include a . . . ”, the process, method, commodity of device that includes or comprises the specified elements may also include other identical elements.

Those skilled in the art should understand that the embodiments of the present disclosure may provide a method, a system or a computer program product. Therefore, the disclosure may employ the form of a complete hardware embodiment, a complete software embodiment or the embodiment combining the software and the hardware. Moreover, the present disclosure may employ the form of the computer program product performed on one or more computer available storage media including a computer available program code (including but not limited to magnetic disc memory, CD-ROM, optical memory and the like).

The description above is merely the embodiments of the present disclosure, but not limited to the present disclosure. For those skilled in the art, various modifications and changes may be made in the present disclosure. Any modifications, equivalent replacements, improvements and the like made within the spirit and principle of the present disclosure shall all fall within the scope of the claims in the present disclosure.

1. A volume controlling method, comprising:
acquiring a smooth volume and a smooth envelope of a voice signal at the current moment;
determining an autocorrelation value of the smooth envelope within a first time period and the smooth envelope within each second time period according to the smooth envelope at the current moment and multiple pre-stored smooth envelopes at historical moments; wherein, the first time period is a time period comprising the current moment and the latest historical moment, and the second time periods are multiple time periods comprising the historical moments;
determining the autocorrelation value having the maximal numerical value from the determined respective autocorrelation values as the maximal autocorrelation value;
determining a combined smooth volume at the current moment according to the smooth volume at the current moment and the maximal autocorrelation value;
determining a volume gain at the current moment according to the combined smooth volume and a predetermined reference volume; and
controlling the volume of a voice signal at next moment according to the volume gain at the current moment.

2. The method according to claim 1, wherein the step of determining the combined smooth volume at the current moment according to the smooth volume at the current moment and the maximal autocorrelation value comprises:
determining a ratio of the maximal autocorrelation value to the quantity of the smooth envelope within the first time period as an average maximal autocorrelation value; wherein, the smooth envelope within the first time period is the smooth envelope at each moment within the first time period;
determining a weighted average value of the smooth volume at the current moment and the maximal average autocorrelation value; and
adopting the weighted average value as the combined smooth volume at the current moment.

3. The method according to claim 1, wherein the step of acquiring the smooth volume and the smooth envelope of the voice signal at the current moment comprises:
acquiring the amplitude of multiple sampling points of the voice signal at the current moment;
calculating the product of the amplitude of each sampling point and the volume gain at the previous moment as a gain amplitude;
determining the average value of the gain amplitudes of the multiple sampling points as an average amplitude; and
determining the smooth volume and the smooth envelope according to the average amplitude.

4. The method according to claim 1, wherein before the step of controlling the volume of a next time voice signal according to the volume gain at the current moment, the method further comprises:
smoothing the volume gain;
performing gain limit on the volume gain smoothed; and
performing gain difference limit on the volume gain after the gain limit, and adopting the volume gain after the gain difference limit as the volume gain at the current moment.

5. The method according to claim 1, before the step of determining the combined smooth volume at the current moment according to the smooth volume at the current moment and the maximal autocorrelation value, further comprises:
determining the maximal autocorrelation value as a maximal autocorrelation value satisfying setting conditions;
wherein, if the maximal autocorrelation value at the current moment exceeds a predetermined maximal autocorrelation threshold, and each maximal autocorrelation value determined between the current moment t and the historical moment t−j has a local peak value, determining that the maximal autocorrelation value at the current moment satisfies the setting conditions; wherein, j is a positive integer greater than 1.

6. A volume controlling device, comprising:
an acquisition module configured to acquire a smooth volume and a smooth envelope of a voice signal at the current moment;
a first determination module configured to determine an autocorrelation value of the smooth envelope within a first time period and the smooth envelope within each second time period according to the smooth envelope at the current moment and multiple pre-stored smooth envelopes at historical moments; wherein, the first time period is a time period comprising the current moment and the latest historical moment, and the second time periods are multiple time periods comprising the historical moments;
a second determination module configured to determine the autocorrelation value having the maximal numerical value from the determined respective autocorrelation values as the maximal autocorrelation value;
a third determination module configured to determine a combined smooth volume at the current moment according to the smooth volume at the current moment and the maximal autocorrelation value;
a fourth determination module configured to determine a volume gain at the current moment according to the combined smooth volume and a predetermined reference volume; and
a control module configured to control the volume of a voice signal at next moment according to the volume gain at the current moment.

7. The device according to claim 6, wherein the third determination module is specifically configured to: determine a ratio of the maximal autocorrelation value to the quantity of the smooth envelope within the first time period as the average maximal autocorrelation value; wherein, the smooth envelope within the first time period is the smooth envelope at each time within the first time period; determine a weighted average value of the smooth volume at the current moment and the maximal average autocorrelation value; and take the weighted average value as the combined smooth volume at the current moment.

8. The device according to claim 6, wherein the acquisition module is specifically configured to: acquire an amplitude of multiple sampling points of the voice signal at the current moment; calculate the product of the amplitude of each sampling point and the volume gain at the previous moment as a gain amplitude; determine the average value of the gain amplitudes of the multiple sampling points as an average amplitude; and determine the smooth volume and the smooth envelope according to the average amplitude.

9. The device according to claim 6, wherein the device further comprises:
a processing module configured to smooth the volume gain;
a first limitation module configured to perform gain limit on the volume gain smoothed; and
a second limitation module configured to perform gain difference limit on the volume gain after the gain limit, and take the volume gain after the gain difference limit as the volume gain at the current moment.

10. The device according to claim 6, wherein the device further comprises:
a fifth determination module configured to determine the maximal autocorrelation value as a maximal autocorrelation value satisfying setting conditions before determining the combined smooth volume at the current moment according to the smooth volume at the current moment and the maximal autocorrelation value;
wherein, if the maximal autocorrelation value at the current moment exceeds a predetermined maximal autocorrelation threshold, and each maximal autocorrelation value determined between the current moment t and the historical moment t−j has a local peak value, determining that the maximal autocorrelation value at the current moment satisfies the setting conditions, wherein j is a positive integer greater than 1.

11. A volume controlling apparatus, comprising:
a processor; and
an memory for storing commands executed by the processor;
wherein the processor is configured to:
acquiring a smooth volume and a smooth envelope of a voice signal at the current moment; determining an autocorrelation value of the smooth envelope within a first time period and the smooth envelope within each second time period according to the smooth envelope at the current moment and multiple pre-stored smooth envelopes at historical moments; wherein, the first time period is a time period comprising the current moment and the latest historical moment, and the second time periods are multiple time periods comprising the historical moments; determining the autocorrelation value having the maximal numerical value from the determined respective autocorrelation values as the maximal autocorrelation value; determining a combined smooth volume at the current moment according to the smooth volume at the current moment and the maximal autocorrelation value; determining a volume gain at the current moment according to the combined smooth volume and a predetermined reference volume; and controlling the volume of a voice signal at next moment according to the volume gain at the current moment.

12. The apparatus according to claim 11, wherein the processor is configured to:
determining a ratio of the maximal autocorrelation value to the quantity of the smooth envelope within the first time period as an average maximal autocorrelation value; wherein, the smooth envelope within the first time period is the smooth envelope at each moment within the first time period; determining a weighted average value of the smooth volume at the current moment and the maximal average autocorrelation value; and adopting the weighted average value as the combined smooth volume at the current moment.

13. The apparatus according to claim 11, wherein the processor is configured to:
acquiring the amplitude of multiple sampling points of the voice signal at the current moment; calculating the product of the amplitude of each sampling point and the volume gain at the previous moment as a gain amplitude; determining the average value of the gain amplitudes of the multiple sampling points as an average amplitude; and determining the smooth volume and the smooth envelope according to the average amplitude.

14. The apparatus according to claim 11, wherein the processor is further configured to:
smoothing the volume gain; performing gain limit on the volume gain smoothed; and performing gain difference limit on the volume gain after the gain limit, and adopting the volume gain after the gain difference limit as the volume gain at the current moment.

15. The apparatus according to claim 11, wherein the processor is further configured to:
determining the maximal autocorrelation value as a maximal autocorrelation value satisfying setting conditions; wherein, if the maximal autocorrelation value at the current moment exceeds a predetermined maximal autocorrelation threshold, and each maximal autocorrelation value determined between the current moment t and the historical moment t−j has a local peak value, determining that the maximal autocorrelation value at the current moment satisfies the setting conditions; wherein, j is a positive integer greater than 1.
